(19) United States
(12) Patent Application Publication
(10) Pub. No.: US 2010/0024458 A1
(43) Pub. Date: Feb. 4, 2010

(54) Air Conditioning and/or Heating System With An Assembled Housing

(75) Inventors: Constantin Schmitt, Schwalmstadt (DE); Christian Battenberg, Schrecksbach (DE); Alfred März, Schrecksbach (DE); Wolfgang Schütz, Edermunde (DE); Klaus Best, Neukirchen (DE)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(73) Assignee: KONVEKTA AG, Schwalmstadt (DE)

(21) Appl. No.: 12/443,932

(22) PCT Filed: Oct. 5, 2007
(86) PCT No.: PCT/DE2007/001781

§ 371 Date: Apr. 1, 2009

(30) Foreign Application Priority Data
Oct. 6, 2006 (DE) 10 2006 047 367.1

(51) Int. Cl. B60H 1/32; F25D 19/00

(52) U.S. Cl. 62/239; 62/297

(57) ABSTRACT

The invention relates to an air conditioning and/or heating system (1) for a vehicle with a housing (5) which comprises at least three housing modules (7, 8) and which houses at least one component (9) of the air conditioning and/or heating system (1), wherein the housing 5 and/or housing part which comprises housing modules (7, 8) contains two housing part end modules (8) and any desired number (n=1, 2, . . . ) of at least one housing part intermediate module, (7) which is positioned between them and is configured with respect to the number and/or the size of the intermediate module(s) of the housing part depending on the structural elements (9) of the air conditioning and/or heating system (1) located between them.

### TECHNICAL FIELD

The invention relates to an air conditioning and/or heating system with an assembled housing according to the preamble of claim 1 for a vehicle having at least one air conditioning and/or heating system provided with a housing comprising at least three housing modules. In addition to other types of vehicles, omnibuses and rail vehicles should be mentioned here, in particular with respect to embodiments of such air conditioning and/or heating system which are assembled in this manner.

A structural element of an air conditioning and/or heating system is in this case a functional part of such a system, such as a heat exchange battery, a blower, a condenser, a compressor or an expansion device which is used to expand the cooling medium. A structural element unit is formed from several assembled structural elements of the same type, such as for example from a plurality of heat exchange batteries which are mutually connected in series.

A heat exchange battery can also contain an evaporator, a heat exchanger used for heating, or both of these elements. A housing module can be a part of the housing or a part of a housing part.

### PRIOR ART

In an air conditioning system, a compressor compresses a gaseous cooling medium and transports the medium through a supply line to a condenser. The condenser, which serves as a heat exchanger, is cooled by the air which is drawn in through an air inlet and carried away through an air outlet. The cooling medium, which was in gaseous form and which is subjected to a high pressure, is thus liquefied. The cooling medium, which is at this time in a fluid form, is supplied through a supply line to an expansion device such as for example a throttle, whereby the pressure on the cooling medium can be relaxed. Due to the relaxation, the cooling medium transitions into the gaseous state and extracts in this manner ambient heat. This extraction of heat affects the ambient air by means of an evaporator which serves as a heat exchanger in the area to be cooled inside the vehicle. The ambient air is in this case drawn in by means of a fan through an inlet opening, supplied to the evaporator, cooled and then supplied through the corresponding openings provided in the area to be cooled inside the vehicle. Therefore, since the temperature of the cooling medium is increased during the cooling of the ambient air, the cooling medium is warmed again. It is then supplied again to the compressor where it is compressed again. The cooling circulation process is thus begun again.

Heat exchangers of a known type are employed in heating systems used in a vehicle. This system warms by means of a fan air which is supplied through a heater heat exchanger and then directed through the openings inside the vehicle.

In a combined air conditioning and heating system for a vehicle, a heat exchange battery comprises for example a heater heat exchanger and an evaporator.

An air conditioning and/or heating system having a modular construction for vehicles is known from U.S. Pat. No. 6,763,669 B1. The rooftop air conditioning system disclosed in this document is constructed from modules which can be joined to each other. In the housing of each of the modules are contained structural elements of a complete air conditioning system such as an evaporator, a condenser and an energy section having a compressor and an expansion device. The disadvantages of a similar modular type of construction include that fact that depending on the number of the modules, multiple identical structural elements of an air conditioning system are present and only one performance class of the structural elements, such as for example an evaporator, is used for each module with a predetermined size. Improved performance of the air conditioning system thus can be achieved only with an appropriately higher number of all respective structural elements of the modules contained in an air conditioning system.

German laid-open patent publication DE 103 28 275 A1 proposes an air conditioning and/or heating system which is assembled from several housing segments, wherein at least one housing element is realized as an inserted part. This inserted part, however, comprises at least one additional structural element, so that an expansion of the air conditioning and/or heating system and thus also of the housing is performed only with the insertion of one structural element which is fixed for this performance class having a corresponding housing segment. On the other hand, an individually produced housing segment must be provided with an appropriately adjusted size for structural elements belonging to a different performance class. Such a wide range of housing elements for each performance class of one structural element is quite expensive.

Moreover, since the structural elements are very large in particular high performance classes, this means that a single housing element used for this purpose will then be also very large, which in turn means that the processing and assembly will be complicated.

In addition, an air conditioning and/or heating system is also known from the German Laid-Open Patent Application DE 10 2004 025 868 A1, wherein the top, bottom and side walls of the housing have a matching length according to the performance class. This is carried out by cutting off or sawing off one part depending on the required length. The part that is then no longer used is included as a surplus in the costs and in the material requirements. Furthermore, the housing wall parts are dimensioned so as to correspond in length to at least one complete structural element, which means that with high performance classes, the structural elements will then be very long and that the housing wall parts will also have a large length. Such long parts are cumbersome and their processing and assembly is complicated.

In German Laid-Open Patent Application DE 199 13 776 A1 is disclosed a modular structure of structural elements of an air conditioning system, in particular for rail vehicles. At least one part of the structural elements is in this case fixed in a single housing shell. However, a modular structure consisting of multiple housing modules and thus also matching the extension of the housing with respective performance classes of the structural elements is not disclosed in the German Laid-Open Patent Application Number DE 199 13 776 A1.

An air conditioning system disclosed in German Laid-Open Patent Application DE 10 2004 032 920 A1, which is suitable also for vehicles, has a housing constructed from two housing shells made of a foamed plastic that are fitted together. However, these housing shells correspond exactly to a fixed size of an air conditioning system and thus also to the size of respective structural elements of the air conditioning device. There is no provision for the possibility of fitting of the housing extension to different performance classes of a structural element of an air conditioning system. The design of the modular air conditioning and/or heating system disclosed in the German Laid-Open Patent Application DE 100 46 935 A1 also fails to provide for such a fitting capability.

In German Laid-Open Patent Application DE 103 45 997 A1 is disclosed a modular construction of a rooftop air conditioning system for vehicles, wherein the housing modules can be connected to each other according to the size of the system. However, because each module contains in this case at least one structural element of the air conditioning system, a higher performance of the modules which are connected to each other can be achieved only through each module of these mutually connected structural elements. However, a matching capability for an extension of the housing depending on the size according to the performance class of the structural element is not provided. At the same time, another disadvantage of the air conditioning system described in German Laid-Open Patent Application DE 103 45 997 A1 is that several expensive smaller structural elements must be mutually connected in order to boost the performance, while a single, larger structural element cannot be integrated in the system.

International Publication of PCT Application WO 2004/098931 discloses a rooftop air conditioning system which has a modular construction.

However, the housing is not explicitly mentioned in an air conditioning system unit which is per se closed and which is constructed either from an evaporator module, or a condenser module, or from two evaporator modules and two condenser modules. At the same time, only one structural element, such as for example an evaporator, can be extended to a single or double length so as to double the performance via a module or via a double module. This represents a major limitation with respect to the variability of the sizes that can be used, or with respect to the performance classes of a structural element of the air conditioning system, such as an evaporator.

The objective of the invention is to provide an improved air conditioning and/or housing system for a vehicle which has a housing provided with at least three housing modules containing at least one structural element of the air conditioning and/or heating system, wherein the housing can be extended in a simple and inexpensive manner for different sizes of a structural element.

### SUMMARY OF THE INVENTION

The task is achieved with an air conditioning and/or heating system for a vehicle which has a housing comprising at least three housing modules containing at least one structural element of the air conditioning and/or heating system, wherein the housing and/or one housing part mounted in one of the housing modules contains two housing part modules and any number (n=1, 2, . . . ) of at least one housing part intermediate module positioned between them, equipped in the extension with at least one of the structural elements of the air conditioning and/or heating system deployed in the housing according to the number and/or the size of the housing part intermediate module(s).

This has the advantage that no specially produced complete housing is required for respective dimensions of a structural element, such as for example different sizes of heat exchange batteries, since a uniform basic housing can be used for different sizes with a number of modules (n=1, . . . ) matching the size of respective structural elements and/or the size of/n the housing modules positioned in between. This makes it possible to reduce the costs and expenditures connected with the production of the housing. The housing and the housing part can be matched in a simple manner in the modular construction type at least with the number and/or size of the housing part intermediate module(s) in the extension according to the size of the structural element determined by the performance class. This makes it possible to insert a corresponding number (n=1, 2, . . . ) of the housing part intermediate modules and/or different sizes of the housing part intermediate module(s) in the basic housing.

Another advantage is obtained with particularly large structural elements of an air conditioning and/or heating system for vehicles. With the distribution of such structural elements which are arranged according to the invention in the housing module of the air conditioning and/or heating system, the units which are thus manufactured, namely the housing modules, are smaller and thus easier to handle.

Advantageous embodiments, modifications and improvements of the object of the invention are described in subordinated claims.

Another advantageous embodiment of the air conditioning and/or heating system provides for an easy attachment of the housing to the roof of a vehicle. The air conditioning and/or heating system can thus be deployed for example in a position which is particularly advantageous for cooling of the area based on technical aspects of the circulation outside of the passenger cell. As an alternative, the housing can be designed so that it can be partially integrated in the roof of the vehicle, wherein the housing is only partially extended over the roof of the vehicle, which results also in another advantage, namely a low height of the roof structure.

According to a further improvement of the present invention, at least two housing modules are connected in a hermetically sealed and waterproof manner. This prevents spraying water from penetrating into the housing, and it will also prevent undesirable intake of additional air.

According to an advantageous modification of the air conditioning and/or heating system, at least two housing modules are rigidly connected with each other. This ensures in particular a sufficient ruggedness of the housing which is located on the vehicle. This can be also further improved with an inseparable connection between the housing modules. Alternatively, the advantage of a separable connection of the housing modules is that defective or damaged housing modules can be quickly replaced, or that only the relevant housing module can be opened when the housing is being repaired.

In an advantageous embodiment of the present invention, the housing is designed to accommodate at least a blower or a blower unit. This makes it possible to store at least each of the blowers or the blowing unit contained in accordance with the invention in the housing.

According to another advantageous embodiment of the air conditioning and/or heating system according to the invention, the housing parts include also a cover part and/or an evaporator case, wherein the cover part and/or the evaporator case contain(s) as a housing unit two housing part modules and any number (n=1, 2, . . . ) housing part modules positioned between them. They are thus matched with the dimensions of a structural element, such as for example an evaporator, in the extension of particularly affected housing parts in a simple manner according to the relevant performance class, and the housing modules are therefore joined together according to the dimensions of the structural elements.

Yet another improvement of the present invention utilizes at least one housing module whose material contains a foamed plastic material. This makes it possible to manufacture a particularly light housing of the air conditioning and/or heating system in an inexpensive manner.

The present invention is particularly suitable for omnibuses and rail vehicles because mostly large elements are employed in an air conditioning and/or heating system in such vehicles.

### BRIEF DESCRIPTION OF FIGURES

Embodiments of the invention are explained below based on the figures.

The figures show the following:

FIG. 1 shows a schematic drawing of an embodiment of an air conditioning and/or heating system according to the invention which is mounted on the roof of an omnibus;

FIG. 2a shows a schematic exploded view drawing of an embodiment of the housing of an air conditioning and/or heating system according to the invention without the top cover part;

FIG. 2b shows a schematic view of the embodiment of the housing of an air conditioning and/or heating system according to the invention in assembled state without the top cover;

FIG. 3a shows a schematic exploded view drawing of an embodiment of the housing comprising the top cover part and an evaporator case of an air conditioning and/or heating system according to the invention;

FIG. 3b shows a schematic view of the top cover part in the embodiment indicated in FIG. 3 in the assembled state having a housing for an air conditioning and/or heating system according to the invention comprising a top cover part and an evaporator case;

FIG. 4 shows a schematic exploded view drawing of another embodiment of an air conditioning and/or heating system which has a housing according to the invention comprising a top cover part and an evaporator case;

FIG. 5a shows a schematic view of an embodiment of an air conditioning and/or heating system containing housing according to the invention which has heat exchange batteries belonging to a lower performance class;

FIG. 5b shows a schematic view of an embodiment of air conditioning and/or heating system containing housing according to the invention which has heat exchange batteries belonging to a median performance class;

FIG. 5c shows a schematic view of an embodiment of air conditioning and/or heating system containing housing according to the invention which has heat exchange batteries belonging to a higher performance class;

FIG. 6 shows a schematic view of embodiments of housing part intermediate modules having two different sizes in a modular construction of an evaporator case of an air conditioning and/or heating system according to the invention.

### DETAILED DESCRIPTION OF THE INVENTION

The same reference symbols are used in the figures for components which have the same or similar function. All symbols should be understood schematically. The scale of the illustrations is not based on real dimension so as to provide a clear representation.

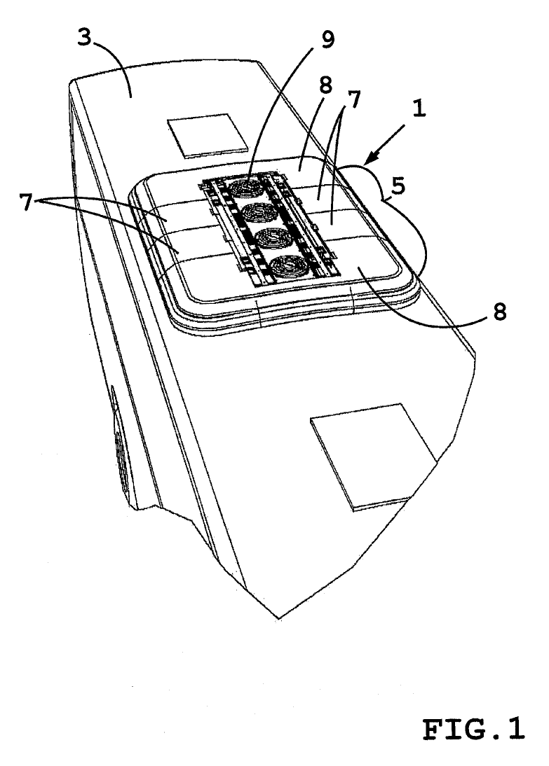

FIG. 1 shows a schematic illustration of an embodiment of an air conditioning and/or heating system 1 mounted on the roof of an omnibus 3. The housing 5 of the air conditioning and/or heating system 1 is constructed from several housing modules 7, 8 according to the invention which are arranged diagonally to the longitudinal direction of the bus roof 3, taking into consideration the fact that two housing part intermediate modules 7 were in this example enclosed between two housing part modules 8 and the structural elements such as heat exchange batteries, blowers and condenser unit 9 are associated with a predetermined performance class. The housing 5 of the air conditioning and/or heating system 1 can be made for example from aluminum, from a stable injection molding plastic material, or from a foamed plastic material.

Structural elements of the air conditioning and/or heating system 1 which are not located in the housing 5 can be accommodated for example inside the vehicle.

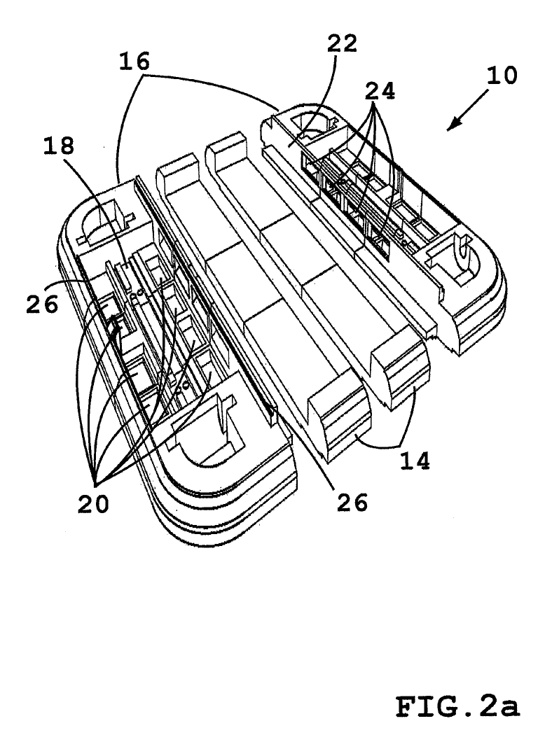

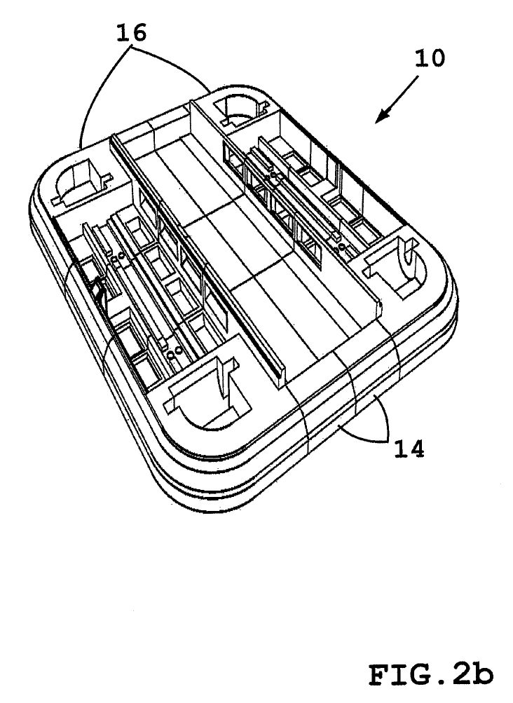

FIG. 2a shows in a schematic exploded view drawing an embodiment of a housing 10 according to the invention without the top cover part in an air conditioning and/or heating system according to the invention.

FIG. 2b shows the same embodiment in the joined state, wherein the connection between the housing modules 14, 16 can be realized according to known methods customary in the art, such as for example gluing. Both outer housing modules 16 are evaporator cases. Between both evaporator cases 16 are in this case located two oblong housing intermediate modules 14 which are provided with a rectangular surface. Depending on which size and therefore which performance class is employed in this intermediate region of the condenser unit, the number of the housing intermediate modules 14 can be varied in accordance with the invention and the entire housing unit 10 can thus be made correspondingly wider or narrower. If no condenser unit is provided, the housing intermediate module can be also omitted.

Each of the evaporator cases 16 is provided along the central region with rectangular recesses 18 for heat exchange batteries which are subsequently fitted therein. Further, the evaporator cases 16 are provided in the bottom region with outer and inner rectangular openings 20 which are used to supply and remove air to and from the internal area of the vehicle. Without being limiting with respect to the number or the form, four inner and four outer openings 20 are provided in the present example for each evaporator case 16. In addition, without being limiting with respect to the number or the form, four respective rectangular openings 24 are provided on the internal faces 22 of the evaporator cases 16 which are used to supply fresh air from outside. The upper inner and outer edges of the evaporator case 16 are provided with rubber sealing components 26 to ensure hermetic and waterproof sealing between the evaporator cases 16 and the top cover part. Other sealing materials known from prior art can be also employed.

Furthermore, a locking hermetic and waterproof sealing of the evaporator case 16 and of the top cover part is also imaginable without a sealing material.

The housing 10 of an air conditioning and/or heating system, which is shown in FIGS. 2a and 2b without the top cover part, can be made for example from aluminum, from a stable injection molding plastic material, or from a foamed plastic material.

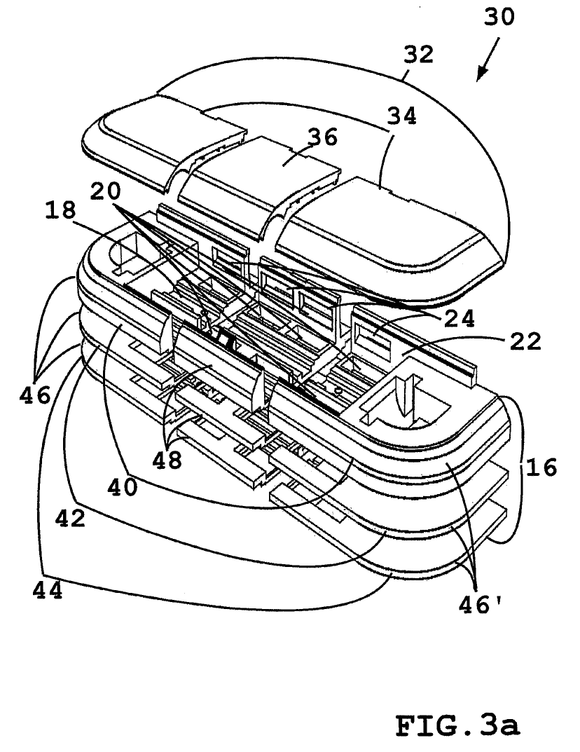

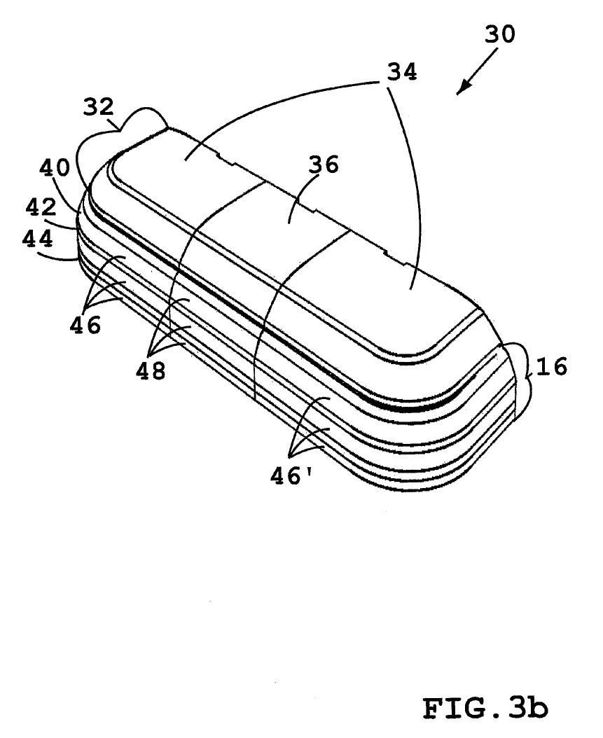

FIG. 3a shows a schematic exploded view drawing of an embodiment according to the invention of a housing 30 according to the invention comprising a top cover part 32 and an evaporator case 16 of an air conditioning and/or heating system. FIG. 3b indicates the housing 30 shown in FIG. 3a in the assembled state.

The top cover 32 comprises two housing part modules 34 and a housing part intermediate module 36 located between them. The evaporator case 16 is constructed from three housing part modules 40, 42, 44, which are disposed on top of each other and which are then fitted together in the longitudinal direction with two housing part modules 46, 46′ and one housing part intermediate module 48. The number of the housing part modules deployed on top of each other corresponds in this case for instance to one upper end module 40, a median intermediate module 42 and a lower end module 44 according to the invention, with the corresponding height of a heat exchange battery associated with a performance class which is to be inserted into the evaporator case 16. For a heat exchange battery which has a greater height, more than three modules of the evaporator 16 case can be set up as required and superimposed on each other, or only one or two housing modules for heat exchange batteries having a smaller height are sufficient for the formation of the evaporator case 16.

In the center of the bottom region of the evaporator case 16 is deployed a rectangular recess 16, which is provided in the longitudinal direction for insertion of a heat exchange battery. Further, the evaporator case 16 is equipped in the bottom area with inner and outer rectangular openings 20 which serve to supply air to and remove it from the inner area of the vehicle. Without being limiting with respect to the number or the form, in this example are used for example four inner and four outer openings 20. In addition, without being limiting with respect to the number and the form, in the inner face 22 of the evaporator case 16 are located four rectangular openings 24 which supply fresh air from outside. The housing 30 can be made for example from aluminum, from a stable injection molding material, or from a foamed plastic material.

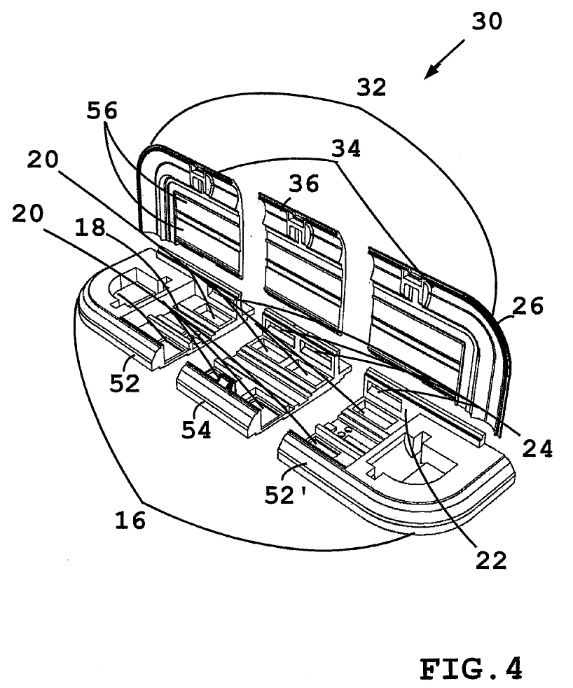

FIG. 4 shows a schematic exploded view drawing of another embodiment of a housing 30 of an air conditioning and/or heating system comprising a top cover part 32 and an evaporator case 16. The top cover part 32 is assembled according to the invention from two housing part end modules 34 and a housing part intermediate module 36 located between them. Two rectangular indentations 56 are deployed in the longitudinal direction on the inner face of the top cover part 32, which provide additional support for inserted heat exchange batteries when the top cover part 32 is closed.

The evaporator case 16 also comprises three housing modules arranged in the longitudinal direction, namely two housing part modules 52, 52′ and one housing part intermediate module 54 located between them. The housing part modules 52, 52′ are provided in the bottom region with inner and outer rectangular openings 20 for supplying and removing air into and from the inner area of the vehicle. Without being limiting with respect to the number and the form, an inner and an outer opening is provided in each housing part end module 52, 52′. In addition, without being limiting with respect to the number and the form, in the inner faces 22 of the housing part end modules 52, 52′ are created rectangular openings which supply fresh air from outside.

Accordingly, without being limiting as to the number and the form, the housing part intermediate module is provided in the inner and outer bottom region with two respective rectangular openings 20, 24. Furthermore, a completely rectangular recess 18 is also provided in the median bottom region in both housing part modules 52, 52′, as well as in the housing part intermediate module 54 which serves for insertion of a heat exchange battery. On both upper edges of the modules 52, 52′, 54 of the evaporator case 16 and on the lower edge of the top cover part 32 are attached rubber sealing components 26 which contribute to hermetic and waterproof sealing of the housing 30. The housing 30 according to the invention can be made for example from aluminum, from a stable injection molding plastic material, or from a foamed plastic material.

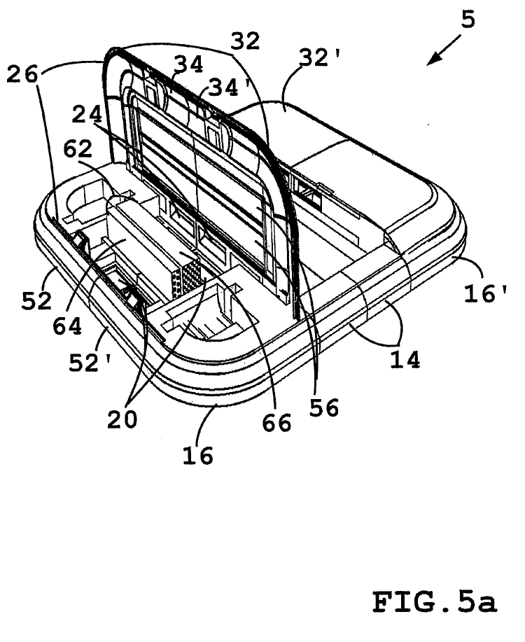

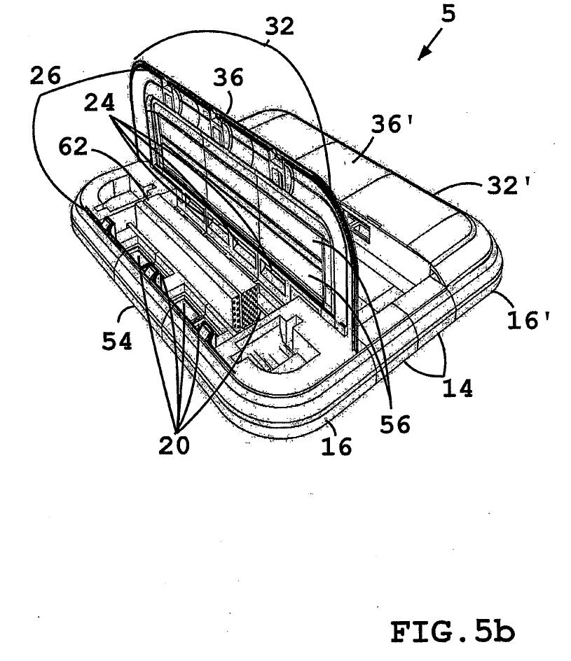

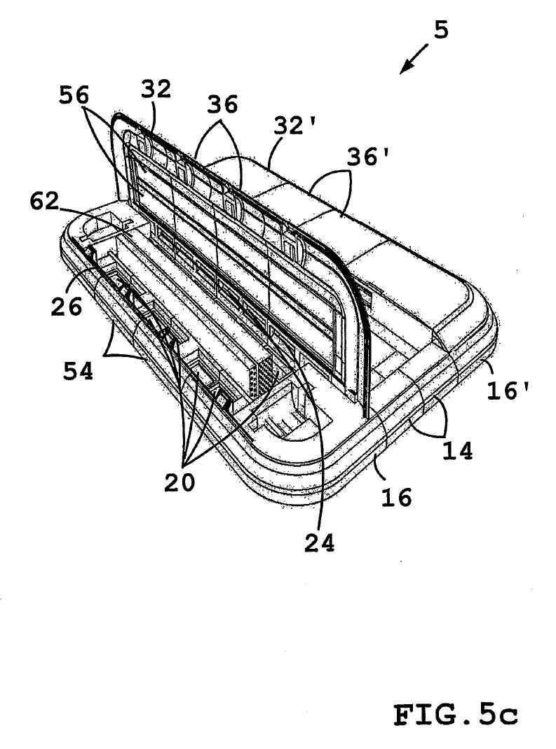

FIG. 5a, 5b and 5c show, respectively, a schematic view of an embodiment of the housing 5 according to the invention of air conditioning and heating systems which have different sizes, wherein the housing shown in FIG. 5a contains a smaller heat exchange battery 62 which belongs to a lower performance class, the housing 5 shown in FIG. 5b contains a median performance class battery and the housing 5 shown in FIG. 5c contains a higher performance class battery 62. The housing 5 can be for example made from aluminum, from a stable injection molding plastic material, or from a foamed injection molding material.

The embodiment is equipped on both outer faces with evaporator cases 16, 16′ which have top cover parts 32, and with housing intermediate parts 14 for a condenser unit deployed between them in the center.

The evaporator case 16 is shown in the FIGS. 5a, 5b and 5c swung open on one side. As shown in FIG. 5a, it comprises two mutually connected housing part end modules 52, 52′ deployed in the longitudinal direction. Also, the top cover parts 32, 32′ do not contain in FIG. 5a any housing part intermediate modules, but only two mutually connected housing part end modules 34, 34′. Both evaporator cases 16, 16′ are respectively equipped in FIG. 5a with a small heat exchange battery 64 and with an evaporator 66 deployed inside. Two rectangular openings 20, 24 which are used to supply and remove air are created both in the inner face of the evaporator cases 16, 16′ and in their outer and inner lateral regions.

The top cover part 32, 32′ of the condenser boxes 16, 16′ are provided in their inner face with rectangular recesses 56 so as to provide additional support for the heat exchange battery 62 in the closed status. Rubber sealing components 26 are attached to the upper edges of the evaporators cases 16, 16′ and to the lower edges of the top cover parts 32, 32′, which components contribute to hermetic and waterproof sealing of the housing 5.

The housing 5 shown in FIG. 5b differs from the one shown in FIG. 5a in that an additional housing part intermediate module 14 is added in order to extend the length in both evaporator cases 16, 16′, as well as in their cover parts 32, 32′ and in both housing intermediate modules 14 provided for the condenser unit. A sufficient amount of space is found with this completion according to the invention for the evaporator cases 16, 16′, even when each is provided with a housing part intermediate module 54 and with the top cover parts 32, 32′ having a housing part intermediate module 36, which has a size belonging to a median performance class. In addition, each of both evaporator cases 16, 16′ is provided in this embodiment with four inner and outer openings 20, 24 in the inner wall and in the bottom region. The recesses 56 in the top cover part 32 are formed so as to correspond to this median size of the heat exchange battery 62.

The housing 5 shown in FIG. 5c differs from the one shown in FIG. 5b in that not only one, but two housing part intermediate respective modules 14 are added to obtain a particularly large extension in both evaporator cases 16, 16′, and in their top cover parts 32, 32′, as well as in both housing intermediate modules 14 which are provided for the housing intermediate unit 14 of the condenser unit. With this completion according to this invention of the evaporator cases 16, 16′ provided with two respective housing part intermediate modules 54, and of the top cover parts 32, 32′ having two housing part intermediate modules 36, enough space is found in the housing 60 for heat exchange batteries 62, which are provided with a size belonging to a higher performance class, or for two in series arranged heat exchange batteries belonging to a lower performance class. Moreover, each of both evaporator cases 16, 16′ is in this embodiment provided with six respective inner and outer openings in the inner wall and in the bottom region. The recesses 56 are formed in the top cover 32 for this size or for two in series arranged smaller heat exchange batteries 62.

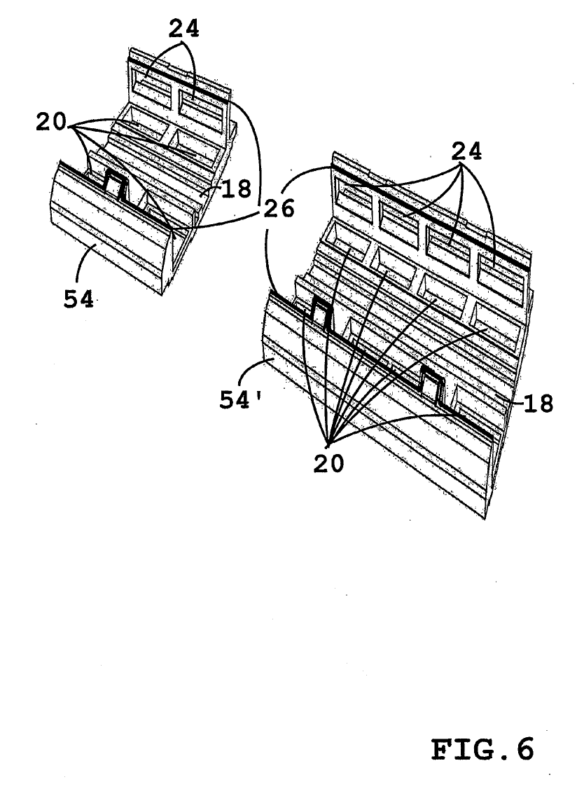

FIG. 6 shows two housing part intermediate modules 54, 54′ according to the invention having a different width which can be inserted into the evaporate case shown in FIG. 4. The narrow housing part intermediate module 54 is equipped also with two respective rectangular openings 24, 20 on the inner wall 22, and also in the inner and outer part of the bottom region. On the other hand, the wider housing part intermediate module 54′ is provided with four respective rectangular openings 20, 24. Along the center of the bottom region of both housing part intermediate modules 54, 54′ is created one recess 18 for a heat exchange battery. On the upper edges of the housing part intermediate modules 54, 54 are attached rubber sealing elements 26. The housing part intermediate modules 54, 54′ can be made for example from aluminum, from a stable injection molding plastic material, or from a foamed plastic material.

The modular housing of the air conditioning and/or heating system according to the invention can be deployed for example in a vehicle in the roof area of the passenger cell, or it can be partially integrated in the passenger roof. The heat exchange batteries, or the heat exchange battery unit and the condenser or the condenser unit can be for example also arranged in a modular construction according to the invention in series in the longitudinal direction on the roof of a vehicle.

Furthermore, the housing according to the invention for an air conditioning and/or heating system comprises at least three housing modules and it is suitable for accommodation of at least one structural element of an air conditioning and/or heating device, wherein the housing is equipped with at least two housing part end modules and contains any number (n=1, 2, . . . ) of at least one module positioned between them, and in the extension, it is equipped with a structural element of the air conditioning and/or heating system which can be inserted into the housing depending on the size, including at least the number and/or the size of the housing part intermediate module(s); wherein protection is claimed in particular also for a housing module according to the invention for an air conditioning and/or heating system.

1. An air conditioning and/or heating system (1) for a vehicle with a housing (5, 10, 30) which houses at least one structural element of the air conditioning and/or heating system (1), comprising:
the housing (5, 10, 30), and/or housing part (16, 16′, 32, 32′) comprising housing modules (7, 8, 14, 34, 36, 40, 42, 46, 46′, 48, 52, 52′, 54, 54′) having two housing part end modules (8, 16, 34, 40, 44, 46, 46′, 52, 52′) and any number (n=1, 2, . . . ) of at least one housing part intermediate module inserted therein (7, 14, 36, 42, 48, 54, 54′), is equipped in its extension with at least the number and/or the size of the housing part intermediate module (7, 14, 36, 48, 54, 54′) depending on the size of at least one structural element (9, 62) deployed in the housing (5, 10, 30) of the air conditioning and/or heating system (1).

2. The air conditioning and/or heating system (1) according to claim 1, wherein the housing (5, 10, 30) is configured so that it can be mounted on the roof (3) of a vehicle.

3. The air conditioning and/or heating system (1) according to claim 1, wherein the housing (5, 10, 30) is configured so that it can be partially integrated in the roof (3) of a vehicle.

4. The air conditioning and/or heating system (1) according to claim 1, wherein at least two housing modules (7, 8, 14, 16, 16′, 32, 32′, 34, 36, 40, 42, 44, 46, 46′, 48, 52, 52′, 54, 54′) are connected to each other so that they are hermetically sealed and waterproof.

5. The air conditioning and/or heating system (1) according to claim 1, wherein at least two of the housing modules (7, 8, 14, 16, 16′, 32, 32′, 34, 36, 40, 42, 44, 46, 46′, 48, 52, 52′, 54, 54′) are rigidly connected with each other.

6. The air conditioning and/or heating system (1) according to claim 1, wherein at least two of the housing modules (7, 8, 14, 16, 16′, 32, 32′, 34, 36, 40, 42, 44, 46, 46′, 48, 52, 52′, 54, 54′) are non-releasably connected to each other.

7. The air conditioning and/or heating system (1) according to claim 1, wherein at least two of the housing modules (7, 8, 14, 16, 16′, 32, 32′, 34, 36, 40, 42, 44, 46, 46′, 48, 52, 52′, 54, 54′) are releasably connected to each other.

8. The air conditioning and/or heating system (1) according to claim 1, wherein the housing (5, 10, 30) is configured to enclose at least one blower or one blower unit.

9. The air conditioning and/or heating system (1) according to claim 1, wherein the housing parts (16, 16′, 32, 32′) include a top cover part (32, 32′) and/or an evaporator case (16, 16′) and the top cover (32, 32′) and/or the evaporator case (16, 16′) contain as a housing module;
two housing part end modules (34, 40, 44, 46, 46′, 52, 52′); and
any number (n=1, 2, . . . ) of housing part intermediate modules (36, 42, 48, 54, 54′) joined in between.

10. The air conditioning and/or heating system (1) according to claim 1, wherein at least one housing module (7, 8, 14, 16, 16′, 32, 32′, 34, 36, 40, 42, 44, 46, 46′, 48, 52, 52′, 54, 54′) is made with at least of a foamed plastic material.

11. The air conditioning and/or heating system (1) according to claim 1, wherein the system is configured to be inserted in or mounted onto an omnibus or a rail vehicle.

12. A housing (5, 10, 30) for an air conditioning and/or heating system (1), comprising at least three housing modules (7, 8, 14, 16, 16′, 32, 32′, 34, 36, 40, 42, 44, 46, 46′, 48, 52, 52′, 54, 54′) suitable for the housing of at least one structural element (9, 62) of an air conditioning and/or heating system (1), wherein the housing (5, 10, 30) contains at least two housing modules (8, 16, 34, 40, 44, 46, 46′, 52, 52′) and any number (n=1, 2, . . . ) of at least one housing part intermediate module (7, 14, 36, 42, 48, 54, 54′) joined in between, equipped in its extension with at least the number and/or the size of the housing part intermediate module (7, 14, 36, 48, 54, 54′) depending on the size of a structural element (9, 62) which can be inserted into the housing (5, 10, 30) of the air conditioning and/or heating system (1).

13. A housing module (7, 8, 14, 34, 36, 38, 40, 42, 44, 46, 46′, 48, 52, 52′, 54, 54′) for a housing (5, 10, 30) suitable for enclosing at least one structural element (9, 62) of an air conditioning and/or heating system (1) for an air conditioning and/or heating system (1), wherein the housing module is structured and arranged to couple to a roof of a vehicle and which housing module is structured and arranged to couple to another housing module.

14. The housing according to claim 12, wherein the housing (5, 10, 30) is configured so that it can be mounted on the roof (3) of a vehicle.

15. The housing according to claim 12, wherein the housing (5, 10, 30) is configured so that it can be partially integrated in the roof (3) of a vehicle.

16. The housing according to claim 12, wherein at least two of the housing modules (7, 8, 14, 16, 16′, 32, 32′, 34, 36, 40, 42, 44, 46, 46′, 48, 52, 52′, 54, 54′) are releasably connected to each other.

17. The housing according to claim 12, wherein the housing parts (16, 16′, 32, 32′) include a top cover part (32, 32′) and/or an evaporator case (16, 16′) and the top cover (32, 32′) and/or the evaporator case (16, 16′) contain as a housing module;
two housing part end modules (34, 40, 44, 46, 46′, 52, 52′); and
any number (n=1, 2, . . . ) of housing part intermediate modules (36, 42, 48, 54, 54′) joined in between.

18. The housing according to claim 12, wherein at least one housing module (7, 8, 14, 16, 16′, 32, 32′, 34, 36, 40, 42, 44, 46, 46′, 48, 52, 52′, 54, 54′) is made with at least of a foamed plastic material.

19. The housing according to claim 12, wherein the system is configured to be inserted in or mounted onto an omnibus or a rail vehicle.
